(19) United States
(12) Patent Application Publication
(10) Pub. No.: US 2008/0216767 A1
(43) Pub. Date: Sep. 11, 2008

(54) Animal leash with a handle

(76) Inventor: Xiao Long Wang, Fort Lee, NJ (US)

Correspondence Address: BERGMAN & SONG, LLP, P.O. BOX 400198, CAMBRIDGE, MA, 02140, US

(21) Appl. No.: 11/823,179

(22) Filed: Jun. 27, 2007

Related U.S. Application Data
(60) Provisional application No. 60/906,101, filed on Mar. 9, 2007.

(51) Int. Cl. A01K 27/00; A01K 29/00

(52) U.S. Cl. 119/795; 16/430

(57) ABSTRACT

A pet leash including a handle, the handle having a grip portion, a capsule portion and an anchor portion. A cavity within the capsule portion is adapted to contain a payload such as a collapsible dog dish or a pet feces collection bag.

### CROSS-REFERENCE TO RELATED APPLICATIONS

Applicant claims the benefit of U.S. Provisional Patent Application No. 60/906,101 filed on Mar. 9, 2007, the enclosure of which is herewith incorporated by reference in its entirety.

### FIELD OF THE INVENTION

The present invention relates to a control device for an animal, and more specifically to an animal leash.

### BACKGROUND

City dwellers with pets commonly walk those pets for exercise and to provide the pet was an opportunity for defecation and urination. Often, the pet is controlled by securing a leash to a collar or harness which is in turn coupled to the pet. It is now commonplace for township and municipal governments to require pet owners, and especially dog owners, to collect and dispose of pet feces deposited by their animals. One convenient method of collecting feces is to capture the feces in a plastic bag. A variety of methods are known for the convenience storage and use of such plastic bags.

In the course of exercise walk, a pet will often become thirsty and/or hungry. For sanitary and health reasons, it is desirable to provide the pet with a source of clean water and/or food during the course of a walk. Generally speaking, it is convenient for pets to drink from an open bowl or dish, rather than from, for example, a bottle. Carrying such a bowl or dish may be inconvenient, however. Accordingly, it is advantageous to a pet owner to have a compact and easily used method for carrying a feces collection bag as well as a drinking bowl.

### SUMMARY OF THE INVENTION

In one embodiment the present invention includes a pet leash having a handle that is adapted to store and carry a feces collection bag and a collapsible drinking bowl.

In one embodiment, the invention includes a handle including a grip member with the first longitudinal axis, an anchor member, and a capsule. The capsule includes a generally cylindrical outer surface coupled to both the grip member and the anchor member. An inner surface of the capsule defines one or more cavities within the capsule portion of the handle. These cavities are adapted to receive various items including, for example, a pet feces collection bag and a collapsible device such as a collapsible food dish or a collapsible water dish. So is

In various embodiments, respective geometric centroids of the capsule, the grip member, the capsule, and the anchor member are disposed substantially coplanar to one another. In other embodiments, the centroids are not coplanar to one another.

In various embodiments of the invention, the anchor member includes variously configured portions including parabolic, rectangular, triangular, circular, and “eyebolt” configurations. In other embodiments, the invention includes a variety of caps, and means for facilitating removal of a payload from within the capsule.

These and other advantages and features of the invention will be more readily understood in relation to the following detailed description of the invention, which is provided in conjunction with the accompanying drawings.

### BRIEF DESCRIPTION OF THE DRAWINGS

FIG. 1 shows a portion of a pet leash including a handle according to one embodiment of the invention;

FIG. 2 shows, in cross-section, a pet leash handle according to one embodiment of the invention;

FIG. 3A shows a pet leash handle according to one embodiment of the invention including a collapsible drinking bowl and a cartridge of feces collecting bags;

FIG. 4 shows, in cross-section, a pet leash handle according to one embodiment of the invention including a tensile member to facilitate removal of a payload;

FIG. 5 shows, in cross-section, a pet leash handle according to a further embodiment of the invention including a spring member to facilitate removal of a payload;

FIG. 6A-4D show, in cross-section, portions of pet leash handle capsules according to respective embodiments of the invention;

FIG. 7A-5C show, in perspective view, portions of pet leash handle capsules according to respective embodiments of the invention;

FIG. 8A-6B show pet leash handles according to respective embodiments of the invention;

FIG. 9A-7B show pet leash handles according to respective embodiments of the invention;

FIG. 10 shows, in side view, a portion of a pet leash according to one embodiment of the invention; and

FIG. 11 shows, in side view, a portion of a pet leash according to a further embodiment of the invention.

### DETAILED DESCRIPTION

The following description is provided to enable any person skilled in the art to make and use the disclosed inventions and sets forth the best modes presently contemplated by the inventors of carrying out their inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

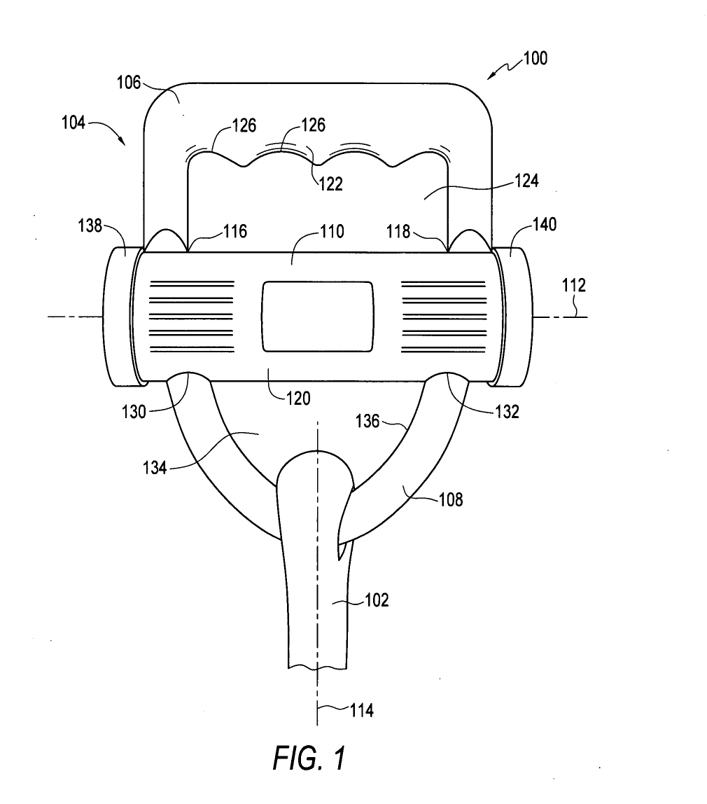

FIG. 1 shows an animal leash 100 according to one embodiment of the invention. The leash 100 includes a substantially flexible tensile member 102 and a handle device 104. In the illustrated embodiment, the handle device 104 includes a grip member 106, an anchor member 108, and a capsule portion 110. As illustrated, the capsule portion 110 has a first longitudinal axis 112. The tensile member 102 has a second longitudinal axis 114. In the illustrated embodiment longitudinal axis 112 is adapted to be disposed substantially transverse to axis 114 when tensile member 102 is in use and under tension.

In the illustrated embodiment, the grip member 106 is coupled to the capsule member 110 at first 116 and second 118 locations on an outer surface 120 of the capsule 110. In one embodiment of the invention, this coupling may be effected by an attachment process perform subsequent to separate preparation of the capsule 110 and the grip member 106. [Welding adhesive mechanical fastener] In another embodiment of the invention, the grip member 106 and capsule 110 may be integrally formed as part of a single manufacturing operation [injection molding, sand casting, die casting, powder metallurgy consolidation].

As illustrated, the grip member 106 includes a distal surface 122 that, along with a portion of surface 120, defines an open region 124 adapted to receive a user's fingers therethrough. In one embodiment of the invention, the surface 122 includes a plurality of concave regions 126, each adapted to impinge on a respective finger of a user's hand. Collectively, the concave regions 126 form a scalloped surface feature according to the illustrated embodiment of the invention.

In the illustrated embodiment, the anchor member 108 has first 130 and second 132 ends coupled to respective regions of surface 120. As with the grip portion, this coupling may be formed by separately forming the capsule and anchor members and subsequently connecting them together, or by integrally forming the capsule and anchor member in a single operation.

As illustrated, a further open region 134 is defined between a proximal surface 136 of the anchor member 108 and a corresponding portion of surface 120. The further open region 134 is adapted to receive a portion of the tensile member 102 therethrough.

In the illustrated embodiment, the capsule 110 is adapted to support first and second caps 138, 140. As will be discussed below in additional detail, the capsule includes one or more storage cavities therewithin for storing various auxiliary equipment. The caps 138, 140 are adapted to retain the auxiliary equipment within the respective storage cavities while the handle 104 is in use.

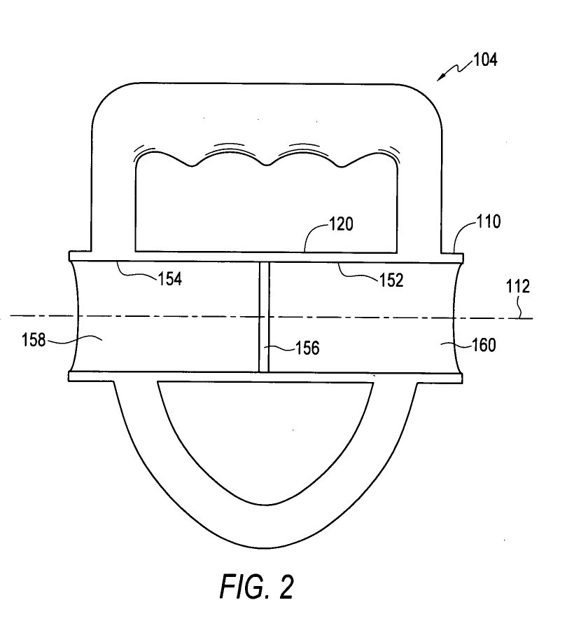

FIG. 2 shows a cross-sectional view of a handle 104 according to one embodiment of the invention. In the illustrated embodiment, the handle includes a capsule portion 110 with a generally circular cylindrical outer surface 120. One of skill in the art will appreciate that other configurations would be appropriate to other applications.

The outer surface 120 is disposed substantially coaxially with respect to a longitudinal axis 112 of the capsule 110. As illustrated, the capsule has a first internal surface 152 and a second internal surface 154. According to one embodiment, the first and second surfaces 152, 154 each has a substantially circular cylindrical form, and each is disposed substantially coaxial to axis 112. A partition 156 is disposed within the capsule 110 so as to form, in combination with the internal surfaces 152, 154, respective first and second internal cavities 158, 160.

It should be noted, that the cylindrical form of internal surfaces 152, 154, and the corresponding shape of cavities 158, 160, is only one of many possible arrangements that in light of this disclosure would be readily apparent to one of ordinary skill in the art. For example, surfaces 152, 154 could define a cavity corresponding to a rectangular prism, a triangular prism, or an arbitrarily shaped region.

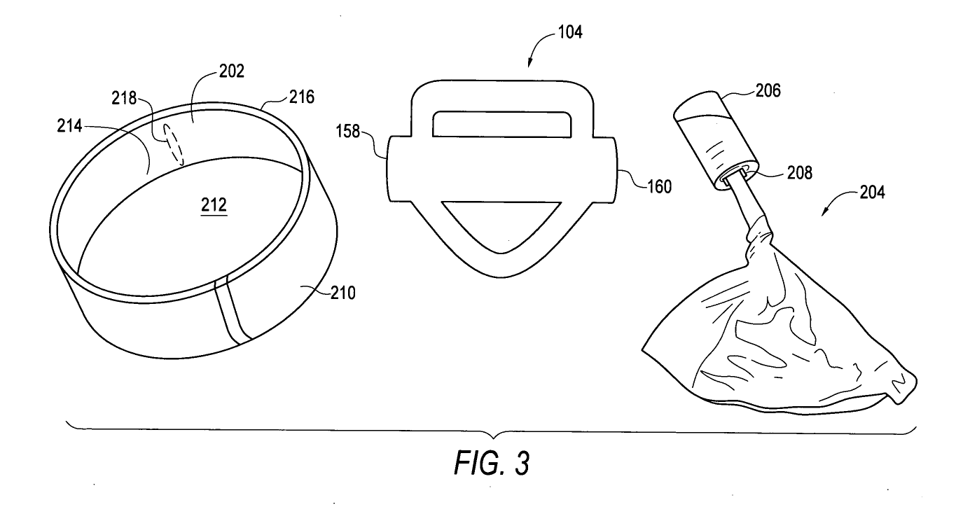

As noted above, cavities 158, 160 are adapted to receive auxiliary equipment, such as equipment that is useful in the course of walking a dog. For example, FIG. 3A shows a collapsible dog dish 202 and a plurality of container bags 204. Each of the collapsible dog dish 202 and the plurality of container bags 204 is adapted to fit within a respective cavities 158, 160 (as shown in FIG. 2) of the handle 104.

According to one embodiment of the invention, the plurality of container bags 204 is organized as an ordered cartridge 206. In one embodiment, the cartridge 206 includes a roll of container bags wherein the roll is adapted to release container bags sequentially from an interior region 208 thereof. In one embodiment of the invention, the container bags are formed of a polymer material such as, for example, polyethylene, low-density polyethylene, high density polyethylene, ultrahigh molecular weight polyethylene and polyamide.

It should be appreciated that the foregoing are merely exemplary of many polymers, copolymers and composites, including natural and synthetic elastomers, that would be apparent as alternatives to one of skill in the art in light of the present invention. In addition, other materials such as, for example, cellulose-based materials, silicon (e.g., glass) based materials are to be employed in alternative embodiments of the invention.

In a further embodiment of the invention, one or more container bags 204 is compressed (e.g., crumpled) and deposited within the cavity 160. For example, a disposable shopping bag can be reused by placing it within the cavity 160. Thereafter, any of the container bags discussed above may be employed for various purposes including the collection of feces.

The collapsible dish 202 is adapted to hold a beverage such as water and/or food. In one embodiment of the invention, the dish 202 includes a side portion 210 and a bottom portion 212. Respective interior surfaces of the side 210 and bottom 212 portions define a concave dish region 214. In one embodiment, the dish 202 is formed of a textile material such as a woven textile material. In another embodiment, the textile material is a non-woven textile material such as, for example, a felt material. According to one embodiment, the textile material is adapted to support a coating such as a polymer coating. The coating is adapted to minimize or prevent absorption of any liquid or gel placed within the concave dish region 214.

According to one embodiment of the invention, the dish 202 is a disposable dish, and is adapted to be discarded after a single use. According to one embodiment, such a disposable dish is formed of a nonwoven polymer material such as, for example, a nonwoven polymer material including fibers formed from high density polyethylene (such as, for example, Tyvek®).

In one embodiment, the dish 202 includes one or more supporting members. In one embodiment a rim supporting member is provided. According to various embodiment, the rim supporting member is formed of a substantially elastic circular member such as, for example, a spring steel wire. In another embodiment of the invention, a supporting stay 218 is formed of a material such as, for example, a substantially rigid polymer. In one embodiment of the invention, one or more of the rim supporting member and the stay are enclosed within pocket formed within the side portion 210. In another embodiment of the invention, one or more of the rim supporting member and the stay are coupled to a surface of the side portion 210 as, for example, by adhesive bonding, ultrasonic welding, or the use of a fastener device such as, for example, a rivet.

According to one embodiment the dish 202 is formed by assembly of discrete pieces of material, such as a for example, by sewing, gluing, thermal bonding or ultrasonic welding. In still another embodiment of the invention, the dish 202 is formed of a substantially solid polymer material such as, for example, a blow-molded polyethylene material.

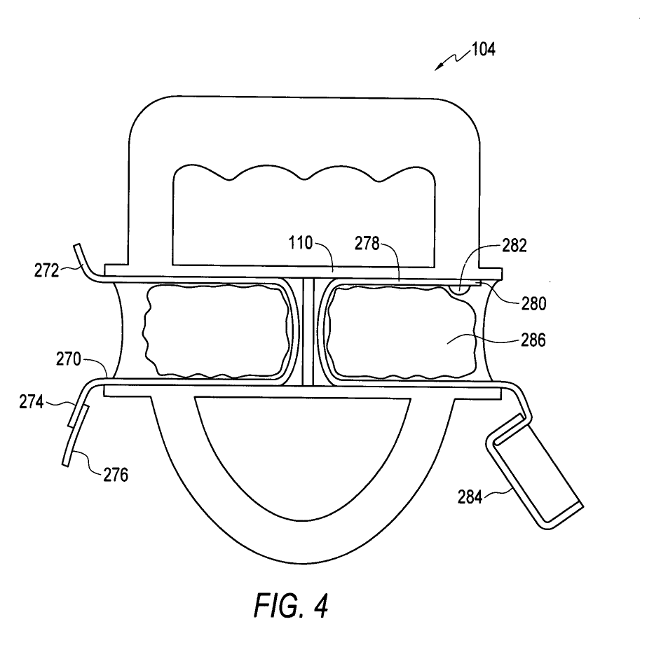

FIG. 4 shows a further embodiment of the invention in which a handle 104 includes means to facilitate removal of a payload from within a cavity of a capsule. In one embodiment, a capsule 100 and includes a cavity adapted to receive a tensile member 270 therein. In one embodiment, the tensile member includes a textile ribbon. In another embodiment, the tensile member includes a textile cord or textile sheet. In various embodiments, the textile ribbon, cord or sheet includes a woven textile material or a non-woven textile material, or a combination thereof. In a still further combination, the tensile member is formed of a metallic material, a natural organic polymer material, a synthetic organic polymer material or a combination thereof. In one embodiment, the tensile member includes a plurality of links.

According to one embodiment, the tensile member is disposed so that first 272 and second 274 ends of the tensile member are adapted to be projected outwardly of the cavity and to be readily grasped by user. In one embodiment, one or more of the first and second ends 272, 274 are integral to, or are adapted to be coupled to, a grasping device 276 such as a tag. In one embodiment of the invention the grasping device 276 is substantially rigid. In another embodiment of the invention, the grasping device 276 is flexible.

In one embodiment of the invention, a tensile member 278 is coupled at one end 280 to an internal wall of the capsule 110. According to one embodiment, this coupling is achieved by the use of a mechanical fastener such as a rivet, screw, a nail, a bread or other mechanical fastening device such as is known in the art. In one embodiment, the mechanical fastening device includes a head 282 adapted to retain the tensile member in place. In one embodiment, an integral portion of the capsule, such as a projecting shaft, is adapted to be formed into a head 282 so as to retain the tensile member 278 in place. In still another embodiment, a tensile member 278 is coupled to an internal wall of the capsule 110 by an adhesive material, by a weld, such as a thermal weld, by an ultrasonic well, or a combination thereof.

In one embodiment of the invention, an end of the tensile member, e.g. 278, is coupled to a cap 284. In such is embodiment, applying tension to a the cap effective to urge a payload 286 outwardly from within the cavity of the capsule 110.

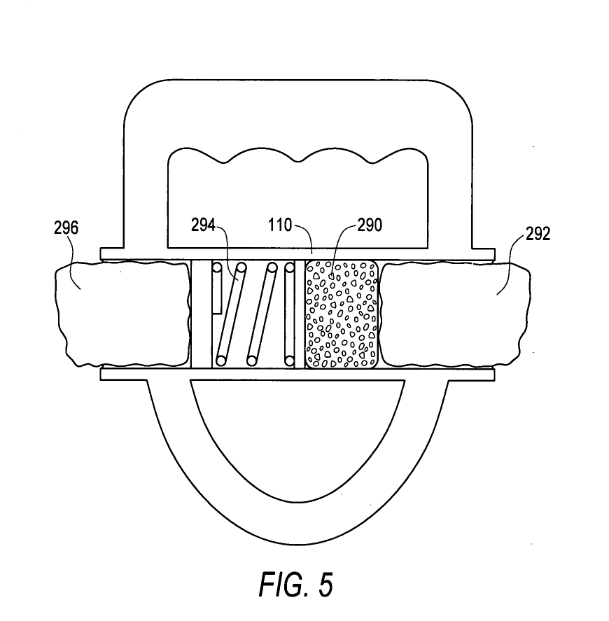

FIG. 5 illustrates further embodiment of the invention, including an embodiment which a compressible material such as a polymer foam 290 is disposed within a cavity of a capsule 110. The compressible foam is adapted to expand upon removal of a cap from the capsule, so that a payload 292 is urged outwardly from the cavity. In a further embodiment, a spring 294, such as a metallic spring, is disposed within a cavity of the capsule 110. The spring 294 is adapted to expand upon removal of a cap from the capsule so that a payload 296 is urged outwardly from the cavity. In one embodiment, a plunger 298 is disposed between the spring 294 and the payload 296. According to one embodiment, this reduces a likelihood of entanglement between the spring 294 and the payload 296.

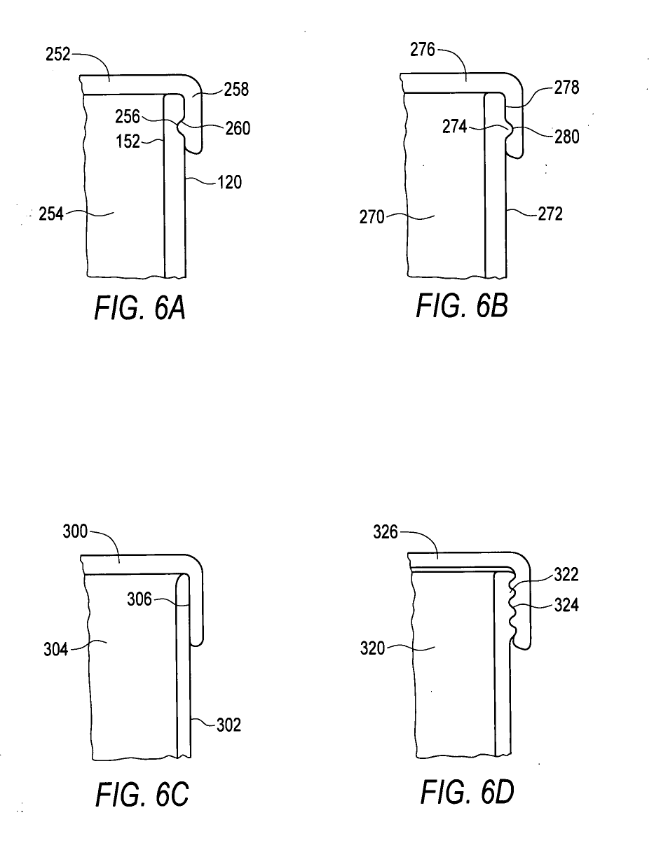

As noted above in relation to FIG. 1, caps 138 and 140 are adapted to retain auxiliary equipment within cavities 158, 160 (as shown in FIG. 2). FIGS. 6A-6D show various modes for coupling exemplary caps to exemplary capsules according to respective embodiments of the invention.

FIG. 6A is a cross-sectional view of a portion of a cap 252 and capsule 254 according to one embodiment of the invention. As illustrated, the capsule includes an external surface 120 and an internal surface 152. In the illustrated embodiment, the external surface 120 includes a circumferential groove 256. In the illustrated embodiment, the circumferential groove 256 has a substantially semicircular concave cross-section.

As illustrated, the cap 252 includes a side region 258 with an internal surface. The internal surface includes, in one embodiment, a substantially circular circumferential protrusion, or ridge, 260. In one embodiment, the ridge 260 includes a cross-section that is substantially complementary to the circumferential groove 256, such that the conference are protrusion 260 is adapted to be removably disposed more or less snugly within the circumferential groove 256.

When a user wishes to remove the cap from the capsule, force is applied to the cap, urging the cap generally along axis 112 (as shown in FIG. 2). In one embodiment, the side region of the 258 deforms flexibly to allow the protrusion 260 move outwardly and exit the groove 256.

In another embodiment of the invention, the protrusion 260 includes a plurality of discrete circumferential bumps rather than a single continuous circumferential protrusion. In various embodiment, the amounts are, for example circular or rectangular. In a still further embodiment of the invention, the protrusion 260 of the bumps, and of the groove 256 is not semicircular, as shown, but is, for example, triangular, rectangular, elliptical, or otherwise shaped so as to effectively retain the cap in place on the capsule.

FIG. 6B shows, in cross-section, a further embodiment of the invention in which a capsule 270 includes an external surface 272 with a protrusion 274, and a cap 276 includes an internal surface 278 with a concave region 280. In various embodiments, the concave region 280 is a concave circumferential groove, a single concave depression, or a plurality of concave depressions.

FIG. 6C shows, in cross-section, another embodiment of the invention in which a cap 300 is supported by an external surface 302 of a capsule 304. In the FIG. 6C embodiment, frictional forces between a portion of external surface 302 of the capsule 304 and a corresponding internal surface 306 of the cap 300 retains the cap in place until it is removed by a user. In various embodiment of the invention, the respective materials of the cap and capsule are chosen to exhibit frictional forces of a desirable level.

FIG. 6D shows still another embodiment of the invention in which a capsule 320 includes an externally threaded surface region 322 adapted to be removably coupled to an internally threaded surface region 324 of a cap 326.

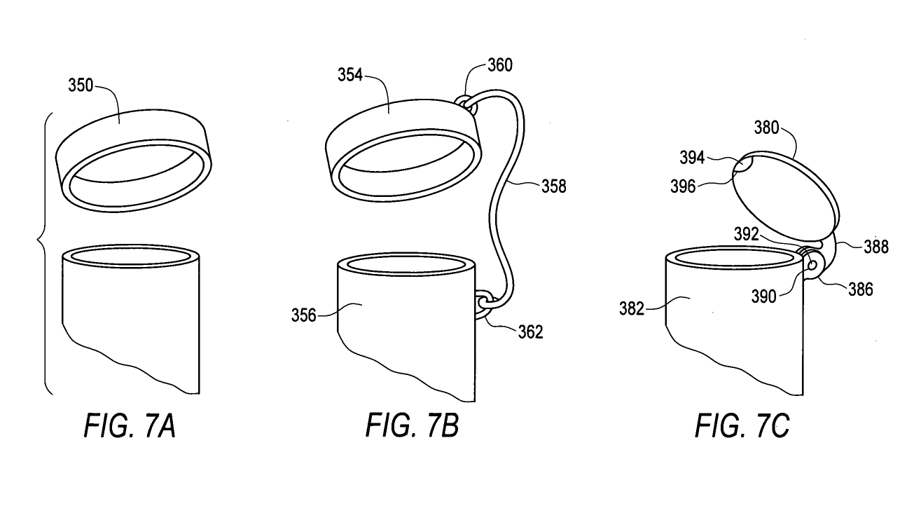

In various embodiment of the invention, a cap, once removed may be discrete and completely free of the capsule, or may be coupled to the capsule by a retainer device. For example, FIG. 7A shows a fully removable cap 350 without a retainer device. FIG. 7B shows a cap 354 and capsule 356 with a tether 358. In the illustrated embodiment, the tether 358 is includes a substantially flexible portion coupled to the cap 354 and capsule 356 at respective eyelets 360, 362. In various embodiments, a substantially flexible member includes, for example, a substantially continuous member, a link chain, a ball chain, a twisted cord, braided cord, and a variety of other flexible devices.

FIG. 7C shows an exemplary embodiment in which a cap 380 is coupled to a capsule 382 by a hinge device 386. In one embodiment of the invention, the hinge device 386 includes a flexible hinge portion, such as a polymer hinge portion. In another embodiment of the invention, as illustrated, the hinge device 386 includes first 388 and second 390 bearing portions and an axle portion 392. According to one embodiment of the invention, a detent mechanism is included to retain the 380 in a closed orientation until a user is ready to open it. In one embodiment of the invention, the detent mechanism is incorporated into the hinge device 386. In another embodiment of the invention, the detent mechanism 394 is coupled to, for example, a circumferential edge 396 of the cap 380.

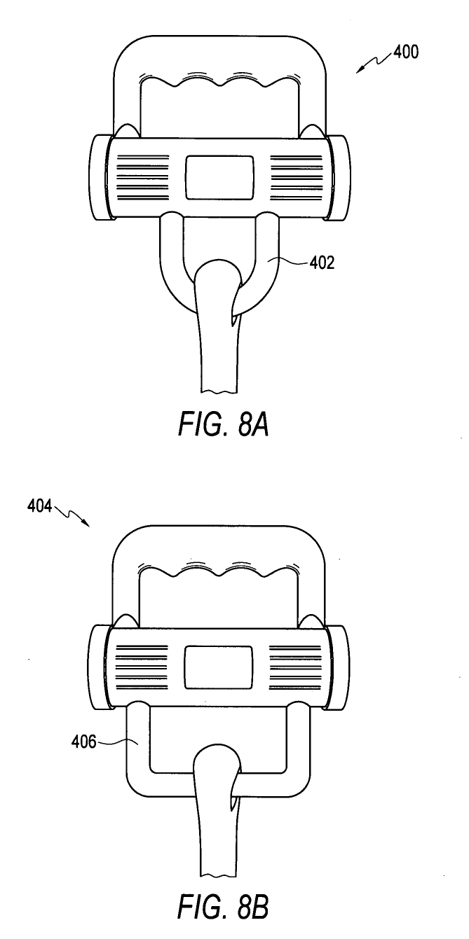

FIGS. 6A-7B show various further exemplary embodiments of the invention. In particular, FIG. 8A shows an embodiment of the invention including a handle 400 having a substantially U-shaped anchor member 402. FIG. 8B shows an embodiment of the invention including a handle 404 having a substantially rectangular anchor member 406. In various embodiments, anchor members 402 and 406 exhibit respective cross-sections that are, for example, circular, elliptical, triangular, rectangular, pentagonal, hexagonal and octagonal.

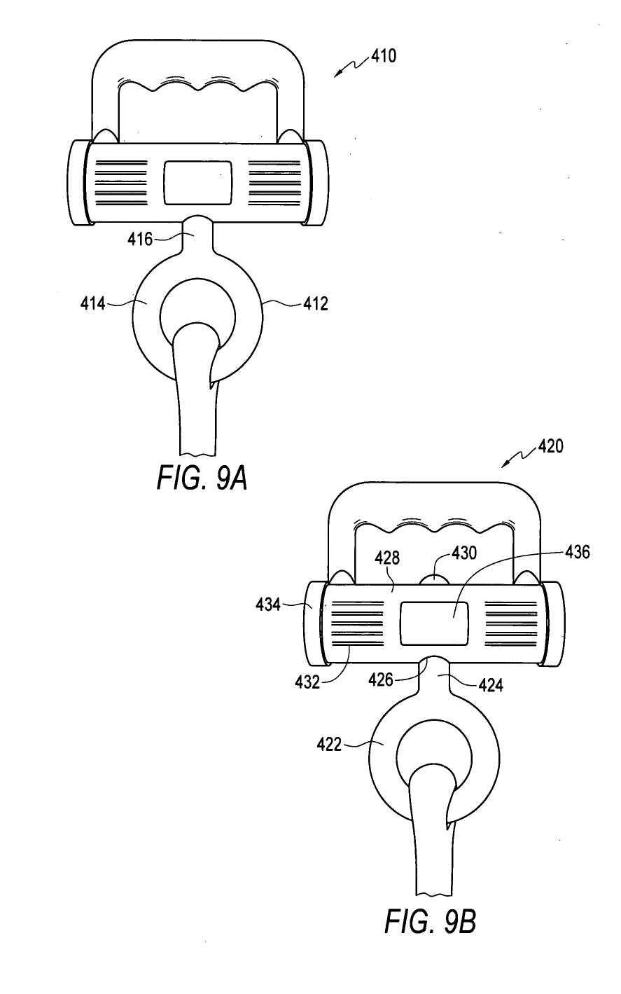

FIG. 9A shows an embodiment of the invention including a handle 410 having a circular or “eye-bolt” style anchor member 412. As illustrated, the anchor member includes a first substantially circular portion 414 and a second shaft portion 416. One of skill in the art will appreciate that this configuration is merely exemplary of a wide variety embodiments including a portion 414 that may be, for example, square, rectangular, elliptical and oval. In like fashion, the shaft portion 416 may include a wide variety of cross-sections such as, for example, circular, square and elliptical.

FIG. 9B shows an embodiment of the invention including a handle 420 with an “eye-bolt” style anchor member 422. In the embodiment of FIG. 9B the shaft portion 424 of the anchor member 422 is disposed within a bore or through-hole 426 of the capsule portion 428. In one embodiment of the invention, the shaft portion 424 of the anchor member 422 includes a retaining mechanism such as, for example, an externally threaded surface coupled to an end currently threaded surface of the bore 426.

In another embodiment of the invention, the anchor member 422 is retained within the through-hole 426 by, for example, forming a rivet head 430 of, or coupling a fastener to, a proximal end of the shaft portion 424. In one exemplary embodiment, the fastener is a nut. In another exemplary embodiment, the fastener is a bolt. In still other embodiments of the invention, an adhesive is used to couple the shaft portion 424 within the bore 426.

In various embodiments of the invention, the capsule portion 428 includes functional surface features such as, for example ridges or grooves 432. These surface features allow, for example, a user to more effectively grip the capsule portion 432 during removal of a cap 434.

In another aspect of the invention, the capsule portion 428 includes a further function of surface feature such as a bezel portion 436. The bezel portion 436 is adapted to support a label for identification of the leash product during vending, or for providing instructions to a user of the device.

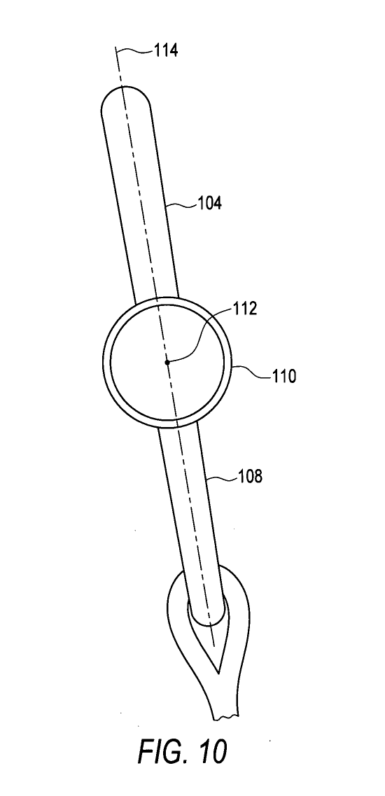

FIG. 10 shows, in side view, one embodiment of the invention in which a capsule portion 110 is disposed with respect to handle portion 104 an anchor member 108 such that longitudinal axis 112 of the capsule portion is disposed substantially coplanar with longitudinal axis 114, where longitudinal axis 114 coincides with respect axes of both the handle portion and the anchor member.

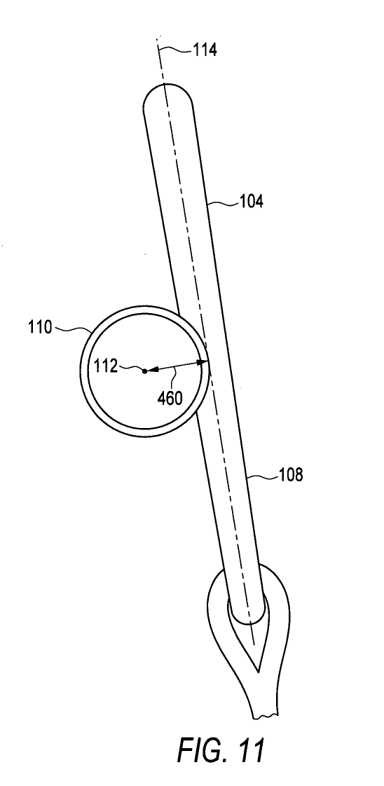

FIG. 11 shows, in side view, a further embodiment of the invention in which capsule portion 110 is disposed offset with respect to handle portion 104 and anchor member 108 such that longitudinal axis 112 is similarly offset from axis 114 by an exemplary offset distance 460.

One of skill in the art, having reviewed the foregoing, will appreciate that a wide variety of materials may be used in forming useful caps according to various embodiments of the invention. For example, a cap may be formed of a metal, a polymer, including, in some embodiments, an elastomeric polymer, a composite material, and of a combination of these materials.

While the exemplary embodiments described above have been chosen primarily from the field of dog leashes, one of skill in the art will appreciate that the principles of the invention are equally well applied, and that the benefits of the present invention are equally well realized in a wide variety of other pet restraint systems including, for example, pet pig restraint systems. Further, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention.

Accordingly, the invention is not to be seen as limited by the foregoing description, but is only limited by the scope of the appended claims.

1. A handle for a pet leash comprising:
a grip member having a first longitudinal axis;
an anchor member; and
a capsule, said capsule being coupled to said grip member and said anchor member, said capsule including a generally cylindrical outer surface having a second longitudinal axis and an inner surface region, said second longitudinal axis be disposed substantially parallel to said first longitudinal axis, said inner surface region defining a cavity within said capsule, said anchor member being adapted to be coupled to a pet leash so that, when in use, said second longitudinal is disposed generally transverse to a third longitudinal axis of a leash member of said pet leash.

2. A handle for a pet leash as defined in claim 1 wherein said grip member includes a scalloped edge.

3. A handle for a pet leash as defined in claim 2 wherein said scalloped edge includes four scallops, said four scallops being adapted to respectively receive four fingers of a user's hand.

5. A handle for a pet leash as defined in claim 1 wherein said grip portion includes a coating, said coating including an elastomeric polymer.

6. A handle for a pet leash as defined in claim 5, wherein said elastomeric polymer comprises a polymer selected from the group consisting of elastic polyesters, elastic polyurethanes, elastic polyamides, and elastic A-B-A′ block copolymers wherein A and A′ and the same or different thermoplastic polymer, and wherein B is an elastomeric polymer block.

7. A handle for a pet leash as defined in claim 1 wherein said anchor member includes a substantially parabolic distal edge.

8. A handle for a pet leash as defined in claim 1 wherein said anchor member includes a substantially convex distal edge.

9. A handle for a pet leash as defined in claim 1 wherein said anchor member includes a substantially angular distal edge.

10. A handle for a pet leash as defined in claim 1 wherein said anchor member includes a substantially concave proximal edge, said proximal edge defining an open region, said open region being adapted to receive a portion of a leash member therethrough, said open region including an area substantially larger than a cross-section of said leash at said open region.

11. A handle for a pet leash as defined in claim 1 wherein said open region comprises an area at least five times as large as said cross-section of said leash member.

12. Handle for a pet leash as defined in claim 1 wherein said generally cylindrical outer surface comprises a generally circularly cylindrical outer surface.

13. A handle for a pet leash as defined in claim 1 wherein said cavity is adapted to receive a collapsible container.

14. A handle for a pet leash as defined in claim 13 wherein said collapsible container comprises a plastic bag.

15. A handle for a pet leash as defined in claim 13 wherein said collapsible container comprises a collapsible food dish.

16. A handle for a pet leash as defined in claim 13 wherein said collapsible container comprises a collapsible beverage dish.

17. A handle for a pet leash as defined in claim 13 wherein said collapsible container comprises a water resistant textile material.

18. A handle for a pet leash as defined in claim 1 further comprising a closure device, said closure device being adapted to be coupled to said capsule, said closure device being adapted to retain a payload within said cavity.

19. A handle for a pet leash as defined in claim 18 wherein said closure device comprises a cap, said cap and inner cap surface, said in inner cap defining a concave region, said concave region being adapted to receive a portion of said generally cylindrical outer surface therewithin.

20. A handle for a pet leash as defined in claim 19 wherein said cap comprises a polymeric material.

21. A handle for a pet leash as defined in claim 19 wherein said cap is adapted to be snapped over said capsule.

22. A handle for a pet leash as defined in claim 19 further comprising a hinge, said hinge being coupled to said capsule and to said cap so as to allow a rotational motion of said cap with respect to said capsule, said rotational motion being adapted to open and close said cavity.

23. A handle for a pet leash as defined in claim 1 wherein said capsule includes a further inner surface region defining a further cavity therewithin.

24. A handle for a pet leash as defined in claim 23 wherein said cavity and said further cavity have respective longitudinal axes, said longitudinal axes being substantially parallel to one another, said capsule further including a barrier disposed between said cavity and said further cavity, said barrier being substantially integral to said capsule.

25. A handle for a pet leash as defined in claim 1 further comprising:
means for facilitating removal of a payload from within said cavity.

26. A pet leash including a handle, said handle comprising:
a first loop portion adapted to receive a leash member, said first loop portion being disposed at a distal end of said handle;
a second loop portion adapted to receive a user's finger, said second loop portion being disposed at a proximal end of said handle, said handle having a first longitudinal axis between said proximal end and said distal end; and
a container portion, said container portion having a second longitudinal axis, said second longitudinal axis being disposed substantially perpendicular to said first longitudinal axis.

27. A leash handle for a pet comprising:
a leash coupling portion; and
a container portion, said container portion having an internal surface region, said internal surface region defining a cavity within said container portion, said cavity being adapted to receive a collapsible dish therewithin, said collapsible dish being adapted for use by said pet.

28. A leash handle for a pet, said leash handle comprising means for transporting a collapsible pet dish, said collapsible pet dish including a textile portion.

29. A leash handle for a pet as defined in claim 28 wherein said textile portion comprises a woven textile material.

30. A leash handle for a pet as defined in claim 28 wherein said textile portion comprises a substantially waterproof textile material.
